(19) United States
(12) Patent Application Publication
(10) Pub. No.: US 2013/0054852 A1
(43) Pub. Date: Feb. 28, 2013

(54) Deadlock Avoidance in a Multi-Node System

(71) Applicants: Charles Fuoco, Allen, TX (US); Akila Subramaniam, Dallas, TX (US)

(72) Inventors: Charles Fuoco, Allen, TX (US); Akila Subramaniam, Dallas, TX (US)

(21) Appl. No.: 13/216,572

(22) Filed: Aug. 24, 2011

(51) Int. Cl. G06F 13/00

(52) U.S. Cl. 710/110

(57) ABSTRACT

Transaction requests in an interconnect fabric in a system with multiple nodes are managed in a manner that prevents deadlocks. One or more patterns of transaction requests from a master device to various slave devices within the multiple nodes that may cause a deadlock are determined. While the system is in operation, an occurrence of one of the patterns is detected by observing a sequence of transaction requests from the master device. A transaction request in the detected pattern is stalled to allow an earlier transaction request to complete in order to prevent a deadlock.

### FIELD OF THE INVENTION

This invention generally relates to management of memory access by multiple requesters, and in particular to split accesses that may conflict with another requestor.

### BACKGROUND OF THE INVENTION

System on Chip (SoC) is a concept that strives to integrate more and more functionality into a given device. This integration can take the form of either hardware or solution software. Performance gains are traditionally achieved by increased clock rates and more advanced process nodes. Many SoC designs pair a digital signal processor (DSP) with a reduced instruction set computing (RISC) processor to target specific applications. A more recent approach to increasing performance has been to create multi-core devices.

Complex SoCs require a scalable and convenient method of connecting a variety of peripheral blocks such as processors, accelerators, shared memory and IO devices while addressing the power, performance and cost requirements of the end application. Due to the complexity and high performance requirements of these devices, the chip interconnect tends to be hierarchical and partitioned depending on the latency tolerance and bandwidth requirements of the endpoints. The connectivity among the endpoints tends to be more flexible keeping in mind future devices that can be derived from the current device with low cost. In this scenario, management of competition for processing resources is typically resolved using a priority scheme.

### BRIEF DESCRIPTION OF THE DRAWINGS

Particular embodiments in accordance with the invention will now be described, by way of example only, and with reference to the accompanying drawings:

FIG. 1 is a functional block diagram of a system on chip (SoC) that includes an embodiment of the invention;

FIG. 2 is a more detailed block diagram of one processing module used in the SoC of FIG. 1;

FIGS. 3 and 4 illustrate configuration of the L1 and L2 caches;

FIG. 5 is a simplified schematic of a portion of a packet based switch fabric used in the SoC of FIG. 1;

FIG. 6 is a timing diagram illustrating a command interface transfer;

FIG. 7 is a timing diagram illustrating a write data burst;

FIG. 8, which includes FIGS. 8A and 8B, is a block diagram illustrating an example 2×2 switch fabric;

FIG. 9 is a schematic illustrating a situation in a packet based switch fabric where a deadlock could occur;

FIG. 10 illustrates prevention of the possible deadlock in FIG. 9;

FIG. 11 is a schematic illustrating another situation in a packet based switch fabric where a deadlock could occur;

FIG. 12 is a flow diagram illustrating operation of deadlock avoidance; and

FIG. 13 is a block diagram of a system that includes the SoC of FIG. 1.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

High performance computing has taken on even greater importance with the advent of the Internet and cloud computing. To ensure the responsiveness of networks, online processing nodes and storage systems must have extremely robust processing capabilities and exceedingly fast data-throughput rates. Robotics, medical imaging systems, visual inspection systems, electronic test equipment, and high-performance wireless and communication systems, for example, must be able to process an extremely large volume of data with a high degree of precision. A multi-core architecture that embodies an aspect of the present invention will be described herein. In a typically embodiment, a multi-core system is implemented as a single system on chip (SoC). As used herein, the term “core” refers to a processing module that may contain an instruction processor, such as a digital signal processor (DSP) or other type of microprocessor, along with one or more levels of cache that are tightly coupled to the processor.

The flexible connectivity and hierarchical partitioning of interconnects based on a split-bus protocol may lead to potential deadlock situations especially during write accesses. Most common bus protocols, especially split architectures, have strongly ordered write data that can lag behind the write command and it is the responsibility of the switch fabric to ensure that the write data is steered from the correct source to the intended destination. A deadlock situation can result when write commands arrive out-of-order at the destination endpoints with respect to the source. Due to strict ordering requirements enforced by the switch fabric, this may prevent the source from issuing write data and may cause a deadlock. Such a deadlock is hard to debug in silicon and may result in expensive debug time.

Embodiments of the invention make use of a concept of local and external slaves. Local slaves are those that are connected to the same switch fabric as a master. External slaves are those that are connected to a different switch fabric via a bridge or a pipeline stage. Write commands from any master to local slaves will not block any subsequent write or read command to another local or external slave. Write commands to external slaves will block subsequent writes to other slaves (local or other externals) until the write data has completed for the current write command. This protocol thus creates blocking between external slaves and external and local slaves but no blocking between local slaves or to the same slave. Only the writes to external slaves need this additional blocking as those write commands may still need to arbitrate another switch fabric and the path for the write data may not be available until the data is actually accepted. But local slaves that are connected directly on the local switch fabric can accept the write data once the write command is arbitrated since there is no further arbitration once the slave accepts the write command.

Another solution to prevent deadlocks is to buffer write data in the interconnect and to not arbitrate the write command until sufficient write data is available for that command. However, this is expensive in terms of silicon real-estate due to the need for adding storage for write data in the interconnect for each endpoint master. A typical interconnect in a complex SoC may have more than forty masters and slaves. This also impacts performance since it has the effect of blocking reads behind the writes. Another solution that can avoid buffering is to simply block a successive write command until the previous write data has completed. However, simple blocking of every successive write impacts performance as any write to another slave, or possibly even the same slave, must block, regardless of whether the write to that slave could actually cause a deadlock.

A protocol will be described in more detail below that does not require additional buffers for write data, nor does it automatically block successive writes that could not result in a deadlock. Only those slaves which connect to another switch fabric that can cause deadlock are marked as external slaves. And only when a write to an external slave is pending would the next write block when it is directed toward another slave.

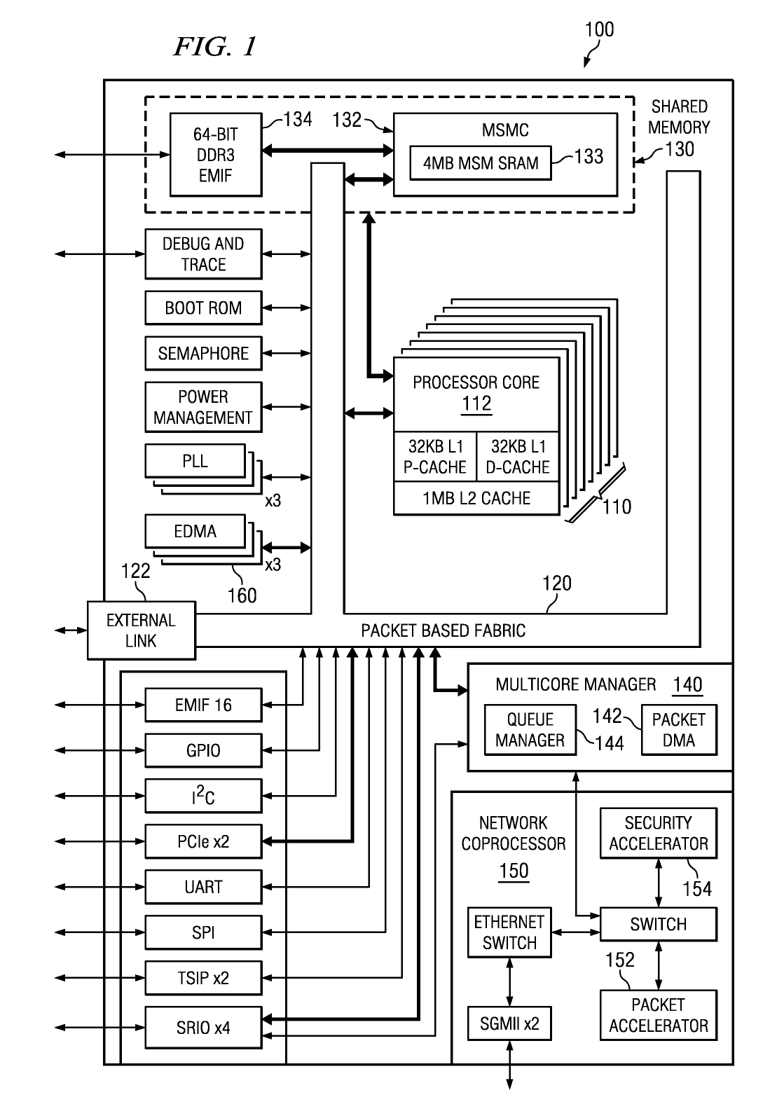

FIG. 1 is a functional block diagram of a system on chip (SoC) 100 that includes an embodiment of the invention. System 100 is a multi-core SoC that includes a set of processor modules 110 that each include a processor core, level one (L1) data and instruction caches, and a level two (L2) cache. In this embodiment, there are eight processor modules 110; however other embodiments may have fewer or greater number of processor modules. In this embodiment, each processor core is a digital signal processor (DSP); however, in other embodiments other types of processor cores may be used. A packet-based fabric 120 provides high-speed non-blocking channels that deliver as much as 2 terabits per second of on-chip throughput. Fabric 120 interconnects with memory subsystem 130 to provide an extensive two-layer memory structure in which data flows freely and effectively between processor modules 110, as will be described in more detail below. An example of SoC 100 is embodied in an SoC from Texas Instruments, and is described in more detail in “TMS320C6678—Multi-core Fixed and Floating-Point Signal Processor Data Manual”, SPRS691, November 2010, which is incorporated by reference herein.

External link 122 provides direct chip-to-chip connectivity for local devices, and is also integral to the internal processing architecture of SoC 100. External link 122 is a fast and efficient interface with low protocol overhead and high throughput, running at an aggregate speed of 50 Gbps (four lanes at 12.5 Gbps each). Working in conjunction with a routing manager 140, link 122 transparently dispatches tasks to other local devices where they are executed as if they were being processed on local resources.

There are three levels of memory in the SoC 100. Each processor module 110 has its own level-1 program (L1P) and level-1 data (L1D) memory. Additionally, each module 110 has a local level-2 unified memory (L2). Each of the local memories can be independently configured as memory-mapped SRAM (static random access memory), cache or a combination of the two.

In addition, SoC 100 includes shared memory 130, comprising internal and external memory connected through the multi-core shared memory controller (MSMC) 132. MSMC 132 allows processor modules 110 to dynamically share the internal and external memories for both program and data. The MSMC internal RAM offers flexibility to programmers by allowing portions to be configured as shared level-2 RAM (SL2) or shared level-3 RAM (SL3). SL2 RAM is cacheable only within the local L1P and L1D caches, while SL3 is additionally cacheable in the local L2 caches.

External memory may be connected through the same memory controller 132 as the internal shared memory via external memory interface 134, rather than to chip system interconnect as has traditionally been done on embedded processor architectures, providing a fast path for software execution. In this embodiment, external memory may be treated as SL3 memory and therefore cacheable in L1 and L2.

SoC 100 may also include several co-processing accelerators that offload processing tasks from the processor cores in processor modules 110, thereby enabling sustained high application processing rates. SoC 100 may also contain an Ethernet media access controller (EMAC) network coprocessor block 150 that may include a packet accelerator 152 and a security accelerator 154 that work in tandem. The packet accelerator speeds the data flow throughout the core by transferring data to peripheral interfaces such as the Ethernet ports or Serial RapidIO (SRIO) without the involvement of any module 110's DSP processor. The security accelerator provides security processing for a number of popular encryption modes and algorithms, including: IPSec, SCTP, SRTP, 3GPP, SSL/TLS and several others.

Multi-core manager 140 provides single-core simplicity to multi-core device SoC 100. Multi-core manager 140 provides hardware-assisted functional acceleration that utilizes a packet-based hardware subsystem. With an extensive series of more than 8,000 queues managed by queue manager 144 and a packet-aware DMA controller 142, it optimizes the packet-based communications of the on-chip cores by practically eliminating all copy operations.

The low latencies and zero interrupts ensured by multi-core manager 140, as well as its transparent operations, enable new and more effective programming models such as task dispatchers. Moreover, software development cycles may be shortened significantly by several features included in multi-core manager 140, such as dynamic software partitioning. Multi-core manager 140 provides “fire and forget” software tasking that may allow repetitive tasks to be defined only once, and thereafter be accessed automatically without additional coding efforts.

Two types of buses exist in SoC 100 as part of packet based switch fabric 120: data buses and configuration buses. Some peripherals have both a data bus and a configuration bus interface, while others only have one type of interface. Furthermore, the bus interface width and speed varies from peripheral to peripheral. Configuration buses are mainly used to access the register space of a peripheral and the data buses are used mainly for data transfers. However, in some cases, the configuration bus is also used to transfer data. Similarly, the data bus can also be used to access the register space of a peripheral. For example, DDR3 memory controller 134 registers are accessed through their data bus interface.

Processor modules 110, the enhanced direct memory access (EDMA) traffic controllers, and the various system peripherals can be classified into two categories: masters and slaves. Masters are capable of initiating read and write transfers in the system and do not rely on the EDMA for their data transfers. Slaves on the other hand rely on the EDMA to perform transfers to and from them. Examples of masters include the EDMA traffic controllers, serial rapid I/O (SRIO), and Ethernet media access controller 150. Examples of slaves include the serial peripheral interface (SPI), universal asynchronous receiver/transmitter (UART), and inter-integrated circuit (I2C) interface.

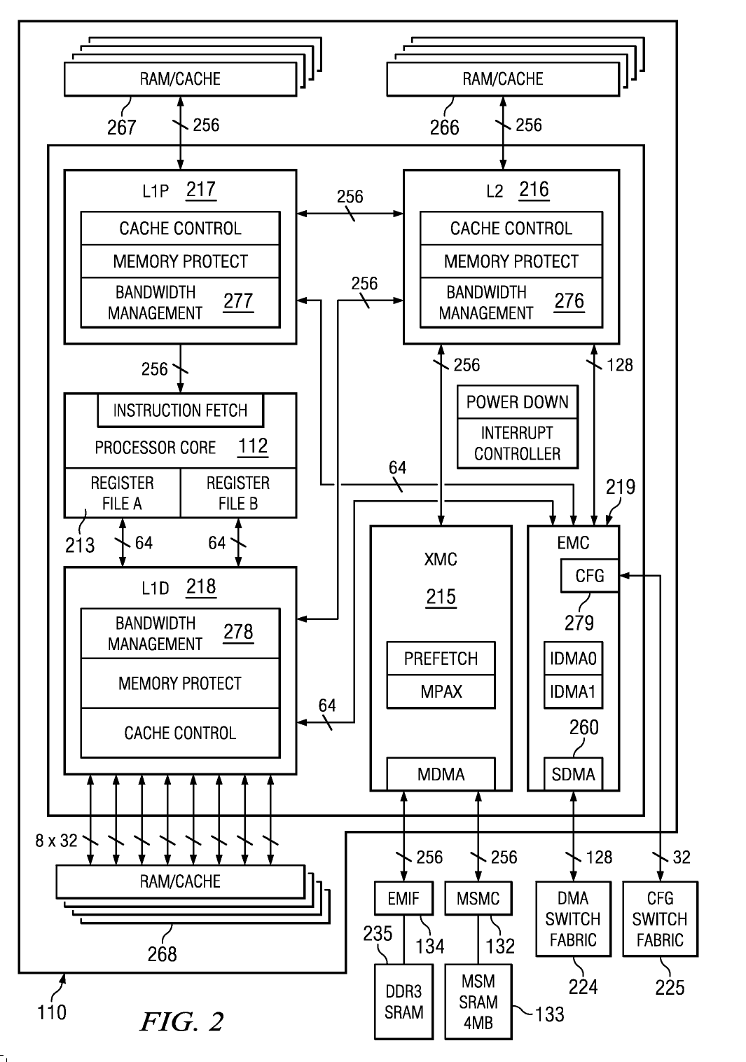

FIG. 2 is a more detailed block diagram of one processing module 110 used in the SoC of FIG. 1. As mentioned above, SoC 100 contains two switch fabrics that form the packet based fabric 120 through which masters and slaves communicate. A data switch fabric 224, known as the data switched central resource (SCR), is a high-throughput interconnect mainly used to move data across the system. The data SCR is further divided into two smaller SCRs. One connects very high speed masters to slaves via 256-bit data buses running at a DSP/2 frequency. The other connects masters to slaves via 128-bit data buses running at a DSP/3 frequency. Peripherals that match the native bus width of the SCR it is coupled to can connect directly to the data SCR; other peripherals require a bridge.

A configuration switch fabric 225, also known as the configuration switch central resource (SCR), is mainly used to access peripheral registers. The configuration SCR connects the each processor module 110 and masters on the data switch fabric to slaves via 32-bit configuration buses running at a DSP/3 frequency. As with the data SCR, some peripherals require the use of a bridge to interface to the configuration SCR.

Bridges perform a variety of functions:

Conversion between configuration bus and data bus.

Width conversion between peripheral bus width and SCR bus width.

Frequency conversion between peripheral bus frequency and SCR bus frequency.

The priority level of all master peripheral traffic is defined at the boundary of switch fabric 120. User programmable priority registers are present to allow software configuration of the data traffic through the switch fabric. In this embodiment, a lower number means higher priority. For example: PRI=000b=urgent, PRI=111 b=low.

All other masters provide their priority directly and do not need a default priority setting. Examples include the processor module 110, whose priorities are set through software in a unified memory controller (UMC) 216 control registers. All the Packet DMA based peripherals also have internal registers to define the priority level of their initiated transactions.

DSP processor core 112 includes eight functional units (not shown), two register files 213, and two data paths. The two general-purpose register files 213 (A and B) each contain 32 32-bit registers for a total of 64 registers. The general-purpose registers can be used for data or can be data address pointers. The data types supported include packed 8-bit data, packed 16-bit data, 32-bit data, 40-bit data, and 64-bit data. Multiplies also support 128-bit data. 40-bit-long or 64-bit-long values are stored in register pairs, with the 32 LSBs of data placed in an even register and the remaining 8 or 32 MSBs in the next upper register (which is always an odd-numbered register). 128-bit data values are stored in register quadruplets, with the 32 LSBs of data placed in a register that is a multiple of 4 and the remaining 96 MSBs in the next 3 upper registers.

The eight functional units (.M1, .L1, .D1, .S1, .M2, .L2, .D2, and .S2) (not shown) are each capable of executing one instruction every clock cycle. The .M functional units perform all multiply operations. The .S and .L units perform a general set of arithmetic, logical, and branch functions. The .D units primarily load data from memory to the register file and store results from the register file into memory. Each .M unit can perform one of the following fixed-point operations each clock cycle: four 32×32 bit multiplies, sixteen 16×16 bit multiplies, four 16×32 bit multiplies, four 8×8 bit multiplies, four 8×8 bit multiplies with add operations, and four 16×16 multiplies with add/subtract capabilities. There is also support for Galois field multiplication for 8-bit and 32-bit data. Many communications algorithms such as FFTs and modems require complex multiplication. Each .M unit can perform one 16×16 bit complex multiply with or without rounding capabilities, two 16×16 bit complex multiplies with rounding capability, and a 32×32 bit complex multiply with rounding capability. The .M unit can also perform two 16×16 bit and one 32×32 bit complex multiply instructions that multiply a complex number with a complex conjugate of another number with rounding capability.

Communication signal processing also requires an extensive use of matrix operations. Each .M unit is capable of multiplying a [1×2] complex vector by a [2×2] complex matrix per cycle with or without rounding capability. A version also exists that allows multiplication of the conjugate of a [1×2] vector with a [2×2] complex matrix. Each .M unit also includes IEEE floating-point multiplication operations, which includes one single-precision multiply each cycle and one double-precision multiply every 4 cycles. There is also a mixed-precision multiply that allows multiplication of a single-precision value by a double-precision value and an operation allowing multiplication of two single-precision numbers resulting in a double-precision number. Each .M unit can also perform one the following floating-point operations each clock cycle: one, two, or four single-precision multiplies or a complex single-precision multiply.

The .L and .S units support up to 64-bit operands. This allows for arithmetic, logical, and data packing instructions to allow parallel operations per cycle.

An MFENCE instruction is provided that will create a processor stall until the completion of all the processor-triggered memory transactions, including:
Cache line fills
Writes from L1D to L2 or from the processor module to MSMC and/or other system endpoints
Victim write backs
Block or global coherence operation
Cache mode changes
Outstanding XMC prefetch requests.

The MFENCE instruction is useful as a simple mechanism for programs to wait for these requests to reach their endpoint. It also provides ordering guarantees for writes arriving at a single endpoint via multiple paths, multiprocessor algorithms that depend on ordering, and manual coherence operations.

Each processor module 110 in this embodiment contains a 1024 KB level-2 memory (L2) 216, a 32 KB level-1 program memory (L1P) 217, and a 32 KB level-1 data memory (L1D) 218. The device also contains a 4096 KB multi-core shared memory (MSM) 132. All memory in SoC 100 has a unique location in the memory map

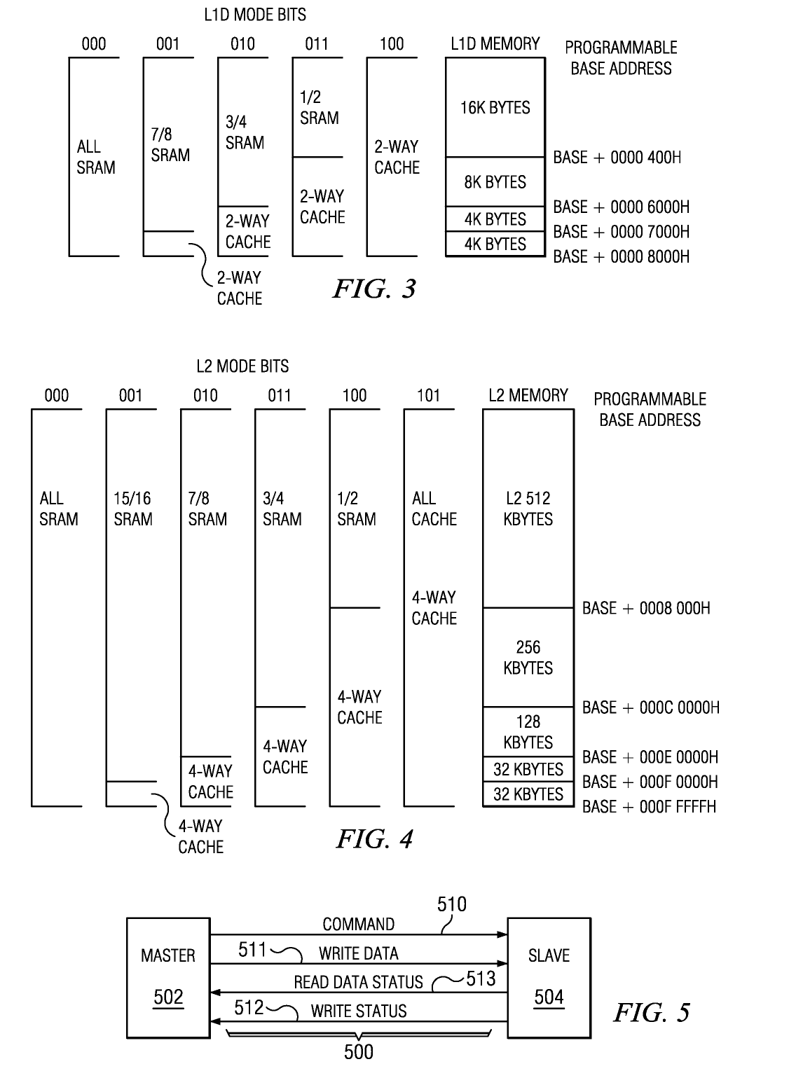

The L1P and L1D cache can be reconfigured via software through the L1 PMODE field of the L1P Configuration Register (L1 PCFG) and the L1 DMODE field of the L1D Configuration Register (L1DCFG) of each processor module 110 to be all SRAM, all cache memory, or various combinations as illustrated in FIG. 3, which illustrates an L1D configuration; L1P configuration is similar. L1D is a two-way set-associative cache, while L1P is a direct-mapped cache.

L2 memory can be configured as all SRAM, all 4-way set-associative cache, or a mix of the two, as illustrated in FIG. 4. The amount of L2 memory that is configured as cache is controlled through the L2MODE field of the L2 Configuration Register (L2CFG) of each processor module 110.

Global addresses are accessible to all masters in the system. In addition, local memory can be accessed directly by the associated processor through aliased addresses, where the eight MSBs are masked to zero. The aliasing is handled within each processor module 110 and allows for common code to be run unmodified on multiple cores. For example, address location 0x10800000 is the global base address for processor module 0's L2 memory. DSP Core 0 can access this location by either using 0x10800000 or 0x00800000. Any other master in SoC 100 must use 0x10800000 only. Conversely, 0x00800000 can by used by any of the cores as their own L2 base addresses.

Level 1 program (L1P) memory controller (PMC) 217 controls program cache memory 267 and includes memory protection and bandwidth management. Level 1 data (L1D) memory controller (DMC) 218 controls data cache memory 268 and includes memory protection and bandwidth management. Level 2 (L2) memory controller, unified memory controller (UMC) 216 controls L2 cache memory 266 and includes memory protection and bandwidth management. External memory controller (EMC) 219 includes Internal DMA (IDMA) and a slave DMA (SDMA) interface that is coupled to data switch fabric 224. The EMC is coupled to configuration switch fabric 225. Extended memory controller (XMC) 215 is coupled to MSMC 132 and to dual data rate 3 (DDR3) external memory controller 134. MSMC 132 is coupled toe on-chip shared memory 133. External memory controller 134 may be coupled to off-chip DDR3 memory 235 that is external to SoC 100. A master DMA controller (MDMA) within XMC 215 may be used to initiate transaction requests to on-chip shared memory 133 and to off-chip shared memory 235.

Referring again to FIG. 2, when multiple requestors contend for a single resource within processor module 110, the conflict is resolved by granting access to the highest priority requestor. The following four resources are managed by the bandwidth management control hardware 276-279:

Level 1 Program (L1P) SRAM/Cache 217

Level 1 Data (L1D) SRAM/Cache 218

Level 2 (L2) SRAM/Cache 216

EMC 219

The priority level for operations initiated within the processor module 110 are declared through registers within each processor module 110. These operations are:

DSP-initiated transfers

User-programmed cache coherency operations

IDMA-initiated transfers

The priority level for operations initiated outside the processor modules 110 by system peripherals is declared through the Priority Allocation Register (PRI_ALLOC). System peripherals that are not associated with a field in PRI_ALLOC may have their own registers to program their priorities.

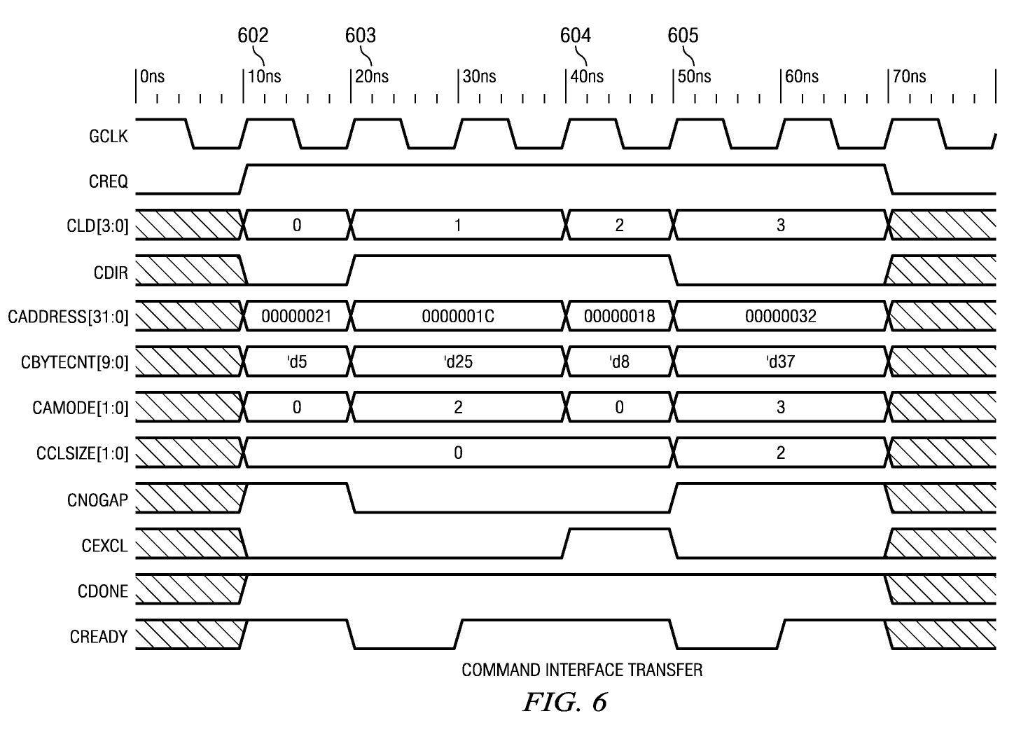

FIG. 5 is a simplified schematic of a portion 500 of a packet based switch fabric 120 used in SoC 100 in which a master 502 is communicating with a slave 504. FIG. 5 is merely an illustration of a single point in time when master 502 is coupled to slave 504 in a virtual connection through switch fabric 120. This virtual bus for modules (VBUSM) interface provides an interface protocol for each module that is coupled to packetized fabric 120. The VBUSM interface is made up of four physically independent sub-interfaces: a command interface 510, a write data interface 511, a write status interface 512, and a read data/status interface 513. While these sub-interfaces are not directly linked together, an overlying protocol enables them to be used together to perform read and write operations. In this figure, the arrows indicate the direction of control for each of the sub-interfaces.

Information is exchanged across VBUSM using transactions that are comprised at the lowest level of one or more data phases. Read transactions on VBUSM can be broken up into multiple discreet burst transfers that in turn are comprised of one or more data phases. The intermediate partitioning that is provided in the form of the burst transfer allows prioritization of traffic within the system since burst transfers from different read transactions are allowed to be interleaved across a given interface. This capability can reduce the latency that high priority traffic experiences even when large transactions are in progress.

### Write Operation

A write operation across the VBUSM interface begins with a master transferring a single command to the slave across the command interface that indicates the desired operation is a write and gives all of the attributes of the transaction. Beginning on the cycle after the command is transferred, if no other writes are in progress or at most three write data interface data phases later if other writes are in progress, the master transfers the corresponding write data to the slave across the write data interface in a single corresponding burst transfer. Optionally, the slave returns zero or more intermediate status words (sdone==0) to the master across the write status interface as the write is progressing. These intermediate status transactions may indicate error conditions or partial completion of the logical write transaction. After the write data has all been transferred for the logical transaction (as indicated by cid) the slave transfers a single final status word (sdone==1) to the master across the write status interface which indicates completion of the entire logical transaction.

### Read Operation

A read operation across the VBUSM interface is accomplished by the master transferring a single command to the slave across the command interface that indicates the desired operation is a read and gives all of the attributes of the transaction. After the command is issued, the slave transfers the read data and corresponding status to the master across the read data interface in one or more discreet burst transfers.

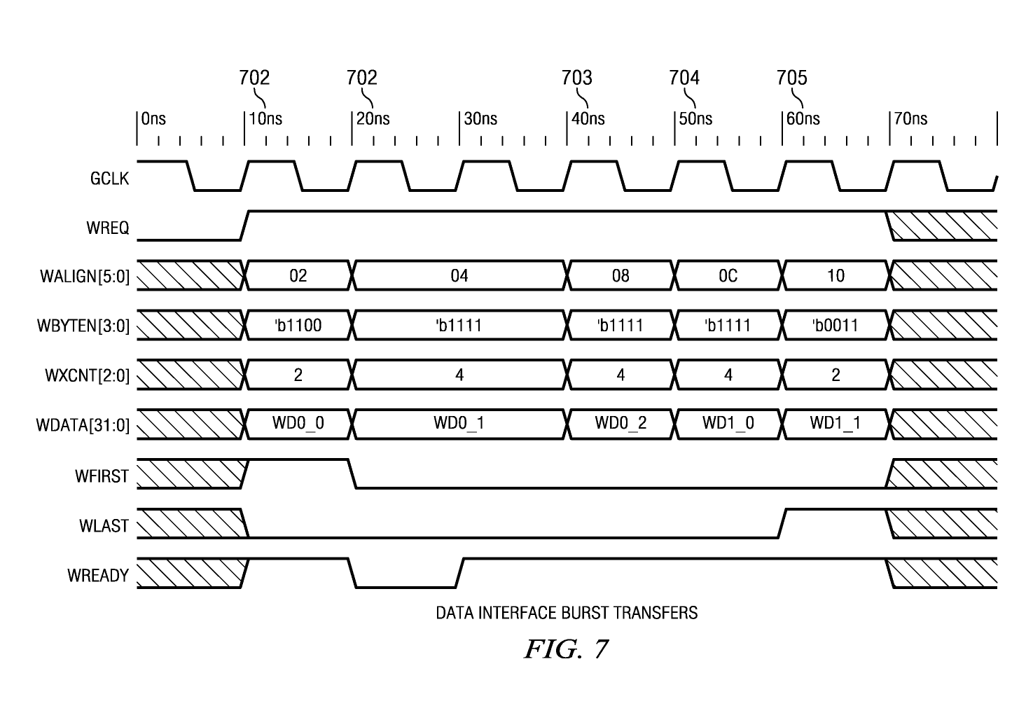

FIG. 6 is a timing diagram illustrating a command interface transfer on the VBUSM interface. The command interface is used by the master to transfer transaction parameters and attributes to a targeted slave in order to provide all of information necessary to allow efficient data transfers across the write data and read data/status interfaces. Each transaction across the VBUSM interface can transfer up to 1023 bytes of data and each transaction requires only a single data phase on the command interface to transfer all of the parameter and attributes.

After the positive edge of clk, the master performs the following actions in parallel on the command interface for each transaction command:
Drives the request (creq) signal to 1;
Drives the command identification (cid) signals to a value that is unique from that of any currently outstanding transactions from this master;
Drives the direction (cdir) signal to the desired value (0 for write, 1 for read);
Drives the address (caddress) signals to starting address for the burst;
Drives the address mode (camode) and address size (cclsize) signals to appropriate values for desired addressing mode;
Drives the byte count (cbytecnt) signals to indicate the size of transfer window;
Drives the no gap (cnogap) signal to 1 if all byte enables within the transfer window will be asserted;
Drives the secure signal (csecure) to 1 if this is a secure transaction;
Drives the dependency (cdepend) signal to 1 if this transaction is dependent on previous transactions;
Drives the priority (cpriority) signals to appropriate value (if used);
Drives the priority (cepriority) signals to appropriate value (if used);
Drives the done (cdone) to appropriate value indicating if this is the final physical transaction in a logical transaction (as defined by cid); and
Drives all other attributes to desired values.

Simultaneously with each command assertion, the slave asserts the ready (cready) signal if it is ready to latch the transaction control information during the current clock cycle. The slave is required to register or tie off cready and as a result, slaves must be designed to pre-determine if they are able to accept another transaction in the next cycle.

The master and slave wait until the next positive edge of clk. If the slave has asserted cready the master and slave can move to a subsequent transaction on the control interface, otherwise the interface is stalled.

In the example illustrated in FIG. 6, four commands are issued across the interface: a write 602, followed by two reads 603, 604, followed by another write 605. The command identification (cid) is incremented appropriately for each new command as an example of a unique ID for each command. The slave is shown inserting a single wait state on the second and fourth commands by dropping the command ready (cready) signal.

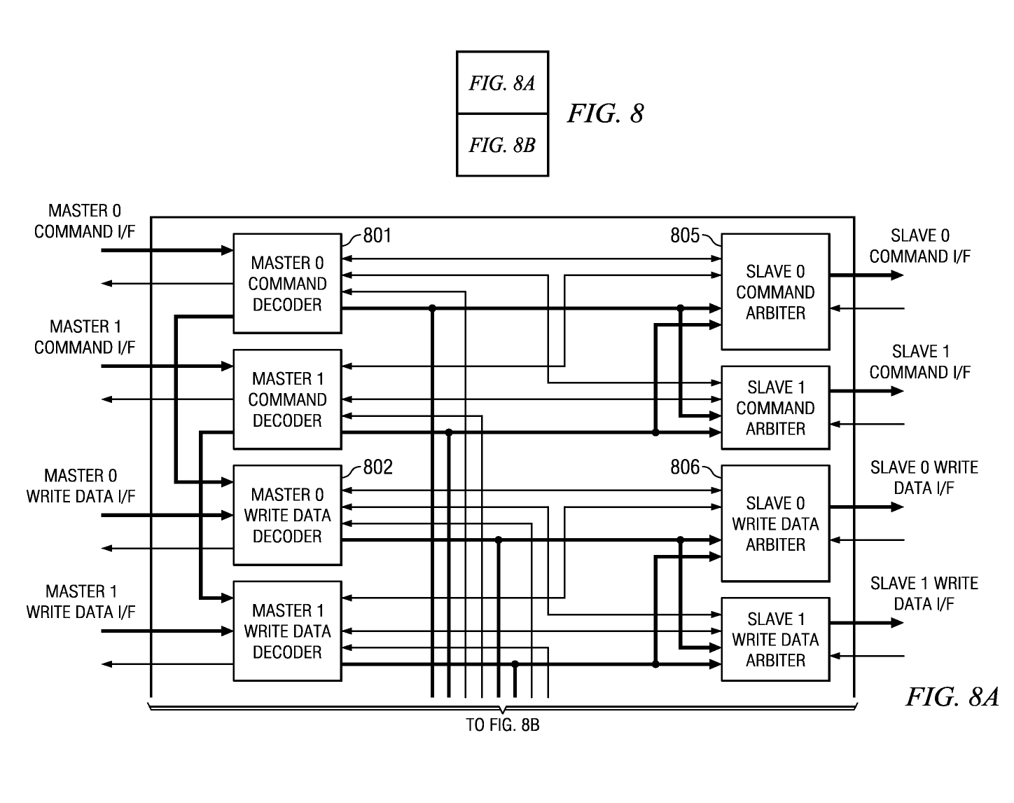

FIG. 7 is a timing diagram illustrating a write data burst in the VBUSM interface. The master must present a write data transaction on the write data interface only after the corresponding write command transaction has been completed on the command interface.

The master transfers the write data in a single burst transfer across the write data interface. The burst transfer is made up of one or more data phases and the individual data phases are tagged to indicate if they are the first and/or last data phase within the burst.

Endpoint masters must present valid write data on the write data interface on the cycle following the transfer of the corresponding command if the write data interface is not currently busy from a previous write transaction. Therefore, when the command is issued the write data must be ready to go. If a previous write transaction is still using the interface, the write data for any subsequent transactions that have already been presented on the command interface must be ready to be placed on the write data interface without delay once the previous write transaction is completed. As was detailed in the description of the creq signal, endpoint masters should not issue write commands unless the write data interface has three or less data phases remaining from any previous write commands.

After the positive edge of clk, the master performs the following actions in parallel on the write data interface:
Drives the request (wreq) signal to 1;
Drives the alignment (walign) signals to the five LSBs of the effective address for this data phase;
Drives the byte enable (wbyten) signals to a valid value that is within the Transfer Window;
Drives the data (wdata) signals to valid write data for data phase;
Drives the first (wfirst) signal to 1 if this is the first data phase of a transaction;
Drives the last (wlast) signal to 1 if this is the last data phase of the transaction;

Simultaneously with each data assertion, the slave asserts the ready (wready) if it is ready to latch the write data during the current clock cycle and terminate the current data phase. The slave is required to register or tie off wready and as a result, slaves must be designed to pre-determine if they are able to accept another transaction in the next cycle.

The master and slave wait until the next positive edge of clk. If the slave has asserted wready the master and slave can move to a subsequent data phase/transaction on the write data interface, otherwise the data interface stalls.

Data phases are completed in sequence using the above handshaking protocol until the entire physical transaction is completed as indicated by the completion of a data phase in which wlast is asserted.

Physical transactions are completed in sequence using the above handshaking protocol until the entire logical transaction is completed as indicated by the completion of a physical transaction for which cdone was asserted.

In the example VBUSM write data interface protocol illustrated in FIG. 7, a 16 byte write transaction is accomplished across a 32-bit wide interface. The starting address for the transaction is at a 2 byte offset from a 256-byte boundary. The entire burst consists of 16 bytes and requires five data phases 701-705 to complete. Notice that wfirst and wlast are toggled accordingly during the transaction. Data phase 702 is stalled for one cycle by the slave de-asserting wready.

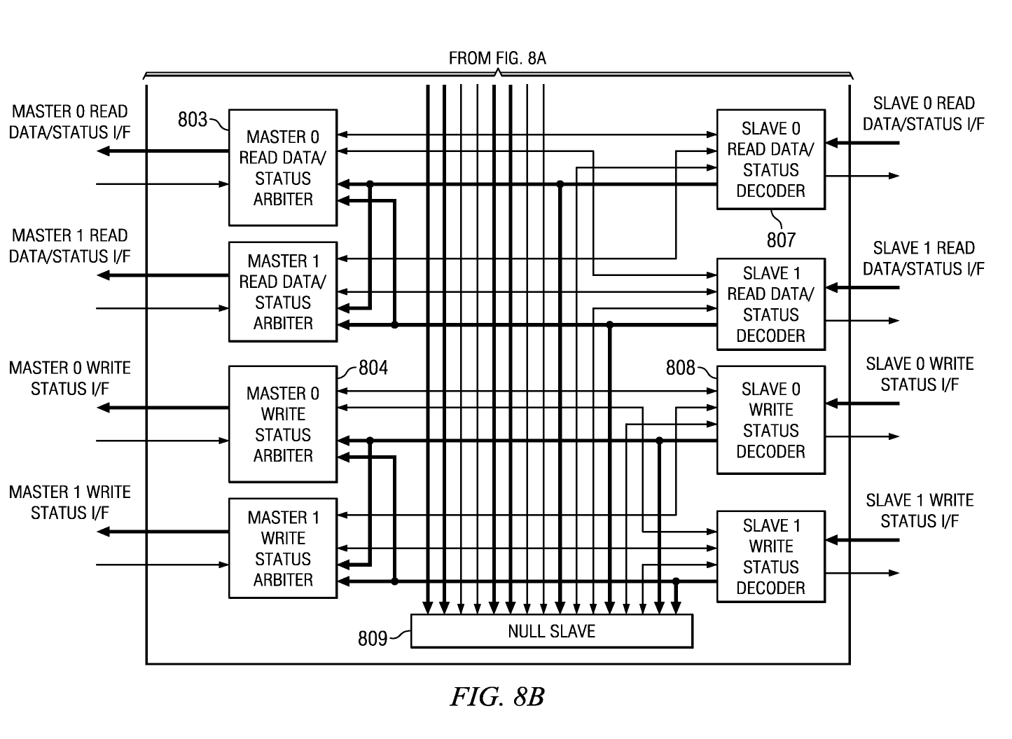

FIG. 8 is a block diagram illustrating an example 2×2 packet based switch fabric, for simplicity. The switched fabric is referred to as a “switched central resource” (SCR) herein. In SoC 100, SCR 120 includes 9×9 nodes for the eight processor cores 110 and the MSMC 132. Additional nodes are included for the various peripheral devices and coprocessors, such as multi-core manager 140.

From the block diagram it can be seen that there are nine different sub-modules within the VBUSM SCR that each perform specific functions. The following sections briefly describe each of these blocks.

A command decoder block 801 in each master peripheral interface is responsible for the following:
Inputs all of the command interface signals from the master peripheral;
Decodes the caddress to determine to which slave peripheral port and to which region within that port the command is destined;
Encodes crsel with region that was hit within the slave peripheral port;
Decodes cepriority to create a set of one-hot 8-bit wide request buses that connect to the command arbiters of each slave that it can address;
Stores the address decode information for each write command into a FIFO that connects to the write data decoder for this master to steer the write data to the correct slave;
Multiplexes the cready signals from each of the command arbiters and outputs the result to the attached master peripheral.

The size and speed of the command decoder for each master peripheral is related to the complexity of the address map for all of the slaves that master can access. The more complex the address map, the larger the decoder and the deeper the logic that is required to implement. The depth of the FIFO that is provided in the command decoder for the write data decoder's use is determined by the number of simultaneous outstanding transactions that the attached master peripheral can issue. The width of this FIFO is determined by the number of unique slave peripheral interfaces on the SCR that this master peripheral can access.

A write data decoder 802 in each master peripheral interface is responsible for the following:
Inputs all of the write data interface signals from the master peripheral;
Reads the address decode information from the FIFO located in the command decoder for this master peripheral to determine to which slave peripheral port the write data is destined;
Multiplexes the wready signals from each of the write data arbiters and outputs the result to the attached master peripheral.

A read data decoder 807 in each slave peripheral interface is responsible for the following:
Inputs all of the read data interface signals from the slave peripheral;
Decodes rmstid to select the correct master that the data is to be returned to;
Decodes repriority to create a set of one-hot 8-bit wide request buses that connect to the read data arbiters of each master that can address this slave;
Multiplexes the rready signals from each of the read data arbiters and outputs the result to the attached slave peripheral.

A write status decoder 808 in each slave peripheral interface is responsible for the following:
Inputs all of the write status interface signals from the slave peripheral
Decodes smstid to select the correct master that the status is to be returned to.
Multiplexes the sready signals from each of the write status arbiters and outputs the result to the attached slave peripheral.

A command arbiter 805 in each slave peripheral interface is responsible for the following:
Inputs all of the command interface signals and one-hot priority encoded request buses from the command decoders for all the master peripherals that can access this slave peripheral
Uses the one-hot priority encoded request buses, an internal busy indicator, and previous owner information to arbitrate the current owner of the slave peripheral's command interface using a two tier algorithm.
Multiplexes the command interface signals from the different masters onto the slave peripheral's command interface based on the current owner.
Creates unique cready signals to send back to each of the command decoders based on the current owner and the state of the slave peripheral's cready.
Determines the numerically lowest cepriority value from all of the requesting masters and any masters that currently have requests in the command to write data source selection FIFO and outputs this value as the cepriority to the slave.
Prevents overflow of the command to write data source selection FIFO by gating low the creq (going to the slave) and cready (going to the masters) signals anytime the FIFO is full.

A write data arbiter 806 in each slave peripheral interface is responsible for the following:
Inputs all of the write data interface signals from the write data decoders for all the master peripherals that can access this slave peripheral;
Provides a strongly ordered arbitration mechanism to guarantee that write data is presented to the attached slave in the same order in which write commands were accepted by the slave;
Multiplexes the write data interface signals from the different masters onto the slave peripheral's write data interface based on the current owner;
Creates unique wready signals to send back to each of the write data decoders based on the current owner and the state of the slave peripheral's wready.

A read data arbiter 803 in each master peripheral interface is responsible for the following:
Inputs all of the read data interface signals and one-hot priority encoded request buses from the read data decoders for all the slave peripherals that can be accessed by this master peripheral;
Uses the one-hot priority encoded request buses, an internal busy indicator, and previous owner information to arbitrate the current owner of the master peripheral's read data interface using a two tier algorithm;
Multiplexes the read data interface signals from the different slaves onto the master peripheral's read data interface based on the current owner;
Creates unique rmready signals to send back to each of the read data decoders based on the current owner and the state of the master peripheral's rmready;
Determines the numerically lowest repriority value from all of the requesting slaves and outputs this value as the repriority to the master.

A write status arbiter 804 in each master peripheral interface is responsible for the following:
Inputs all of the write status interface signals and request signals from the write status decoders for all the slave peripherals that can be accessed by this master peripheral;
Uses the request signals, an internal busy indicator, and previous owner information to arbitrate the current owner of the master peripheral's write status interface using a simple round robin algorithm;
Multiplexes the write status interface signals from the different slaves onto the master peripheral's write status interface based on the current owner;
Creates unique sready signals to send back to each of the write status decoders based on the current owner and the state of the master peripheral's sready.

In addition to all of the blocks that are required for each master and slave peripheral there is one additional block that is required for garbage collection within the SCR, null slave 809. Since VBUSM is a split protocol, all transactions must be completely terminated in order for exceptions to be handled properly. In the case where a transaction addresses a non-existent/reserved memory region (as determined by the address map that each master sees) this transaction is routed by the command decoder to the null slave endpoint 809. The null slave functions as a simple slave whose primary job is to gracefully accept commands and write data and to return read data and write status in order to complete the transactions. All write transactions that the null slave endpoint receives are completed by tossing the write data and by signaling an addressing error on the write status interface. All read transactions that are received by the null endpoint are completed by returning all zeroes read data in addition to an addressing error.

### Deadlock

The flexible connectivity and hierarchical partitioning of interconnects based on a split-bus protocol can lead to potential deadlock situations, especially during write accesses. Within SoC 100, SCR 224 enforces a strongly ordered protocol. Write data may lag behind the write command and it is the responsibility of the switch fabric to ensure that the write data is steered from the correct source to the intended destination. A deadlock situation could result if write commands arrive out-of-order at the destination endpoints with respect to the source that will prevent the source from issuing write data and causing deadlock. Such a deadlock is hard to debug in silicon and result in expensive debug time and resource.

In order to prevent such deadlocks, SCR 224 includes a concept of local and external slaves. Local slaves are those that are connected to the same switch fabric as the masters. External slaves are those that are connected to a different switch fabric via a bridge or a pipeline stage. It can be determined before hand what pattern of transactions commands might result in a deadlock. The SCR monitors each transaction command and whenever it detects a potential deadlock pattern, it stalls the possibly offending command until it is safe to proceed.

For example, write commands from any master to its local slaves will not block any subsequent write or read command to another local or external slave. However, a write command to external slaves will block subsequent writes to other slaves (local or other externals) until the write data has completed for the current write command.

The solution thus creates blocking between external slaves and external and local slaves but no blocking between local slaves or to the same slave. Only the writes to external slaves need this additional blocking as those write commands may need to arbitrate another switch fabric and the path for the write data may not be available until the data is actually accepted. Local slaves that are connected directly on the local switch fabric can accept the write data once the write command is arbitrated since there is no further arbitration once the slave accepts the write command.

This solution provides an area efficient solution to the deadlock problem by not requiring storage of write data at every master endpoint and by blocking commands only at the points that are potential sources of deadlock. It is also more efficient then solutions which simply just block successive write commands until the previous write data is completed.

Another solution to this problem is to buffer write data in the interconnect and not arbitrate the write command until sufficient write data is available for that command. This is expensive in terms of silicon real-estate due to the need for adding storage for write data in the interconnect for each endpoint master. A typical interconnect in a complex SoC has more than forty masters and slaves. This also impacts performance since it has the effect of blocking reads behind the writes. Another solution that can avoid buffering is to simply block a successive write command until the previous write data has completed. This impacts performance as any write to another slave (possibly even the same slave) must block, regardless of whether the write to that slave could actually cause a deadlock.

An advantage of blocking only when a particular access pattern occurs is that it does not require additional buffers for write data, nor does it automatically block successive writes that could not result in a deadlock. Only those slaves which connect to another switch fabric that can cause deadlock are marked as external slaves. And only when a write to an external slave is pending would the next write block when it is directed toward another slave.

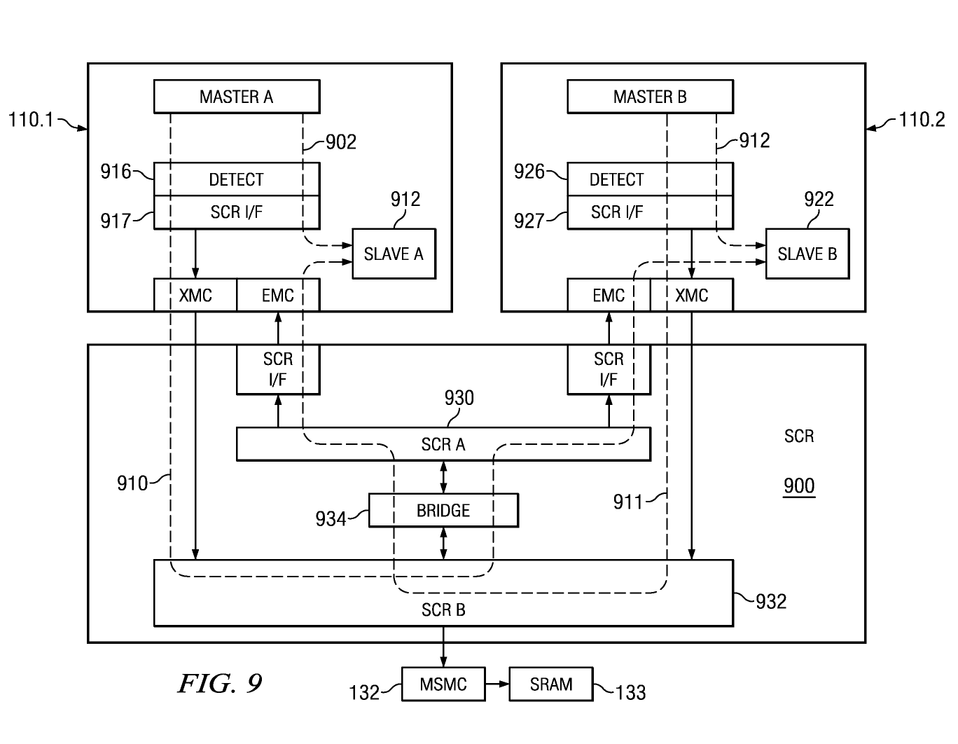

FIG. 9 is a schematic illustrating a situation in SCR 900 where a deadlock could occur. This example includes processor modules 110.1, 110.2, as described above. In this embodiment, SCR 900 is implemented as two separate portions 930, 932 that are coupled via bridge 934. Each XMC is an SCR master interface and is coupled to SCR 932 and provides access to shared SRAM 133 via MSMC 132, as described above. As such, SRAM 133 is considered a local resource to each processor module since they are on the same switch fabric. In this embodiment, SCR 932 extends into each processor module 110 with an SCR interface 917, 927. In this configuration SCR 932 participates in accesses to local resources within the processor module; such as to the shared SRAM 266, 267, 268 within each processor module, as described with regard to FIGS. 2-4. These resources will be loosely referred to as slave A 912 and slave B 922 in this example. Each EMC is an SCR slave interface and is coupled to SCR 930 to provide access to the shared SRAM 266, 267, 268 within each processor module.

SCR portion 930 is separated from SCR portion 932 by bridge 934; thus, any transaction initiated by a master on one processor module to a slave in another processor module must first traverse SCR 932, bridge 934 and then SCR 930. Therefore, the slaves are treated as external resources to masters in other processor modules.

In this example, master A in domain processor module 110.1 may initiate an external write request 901 to slave B in processor module 110.2, then initiate local write request 902 to local slave SRAM 133. At the same time, master B in domain 911 may initiate an external write request 911 to slave A in processor module 110.2, then initiate local write request 912 to local slave SRAM 133. Since strict ordering is maintained on all transactions, the following conditions occur:
Write ordering from master A: write 901 to remote slave B, write 902 to local slave A
Write ordering from master B: write 911 to remote slave A, write 912 to local slave B
Writes data arrive in this order at slave A: local write 902 is first, external write 911 is second due to bridge delay
Writes data arrive in this order at slave B: local write 912 is first, external write 902 is second due to bridge delay
At slave A, external write 911 is blocked by completion of local write 902 due to strict ordering enforcement
At slave A, local write 902 cannot start until external write 901 is completed due to strict ordering enforcement
At slave B, external write 901 is blocked by completion of local write 912 due to strict ordering enforcement
At slave B, local write 902 cannot start until external write 911 is completed due to strict ordering enforcement

Thus, a deadlock would occur since neither slave can complete the requested operations. Since this situation would only occur if the two request sequences are initiated on the same or almost the same clock, the occurrence is rare and very difficult to trouble shoot.

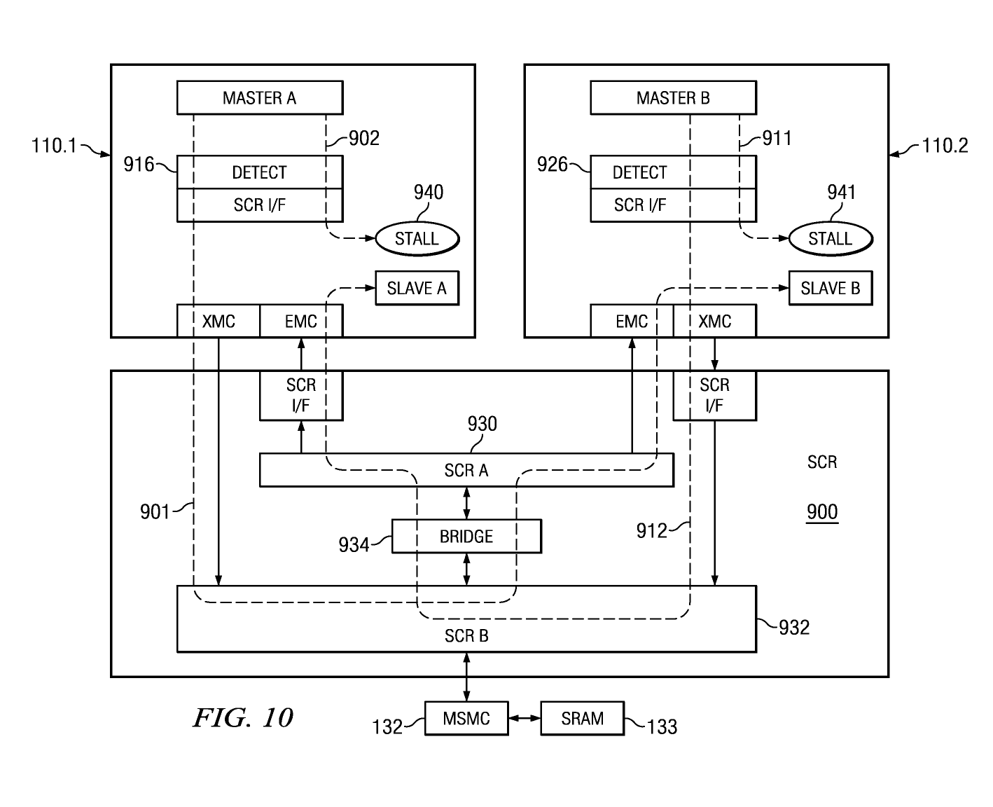

FIG. 10 illustrates prevention of the possible deadlock in FIG. 9. Based on the discussion above, it has been determined that a write pattern that includes a write to an external slave followed by a write to a local slave may result in a deadlock. Detection logic 916 in processor master 110.1 watches each transaction command that is imitated by master A. Any time a “write external followed by a write local” pattern is observed, detection logic 916 causes the second write 902 to be stalled 940 until external write 901 is completed.

In similar manner detection logic 926 in processor module 110.2 watches each transaction command that is initiated by master B. Any time a “write external followed by a write local” pattern is observed, detection logic 926 causes the second write 912 to be stalled 931 until external write 911 is completed.

In this manner, Master A and Master B are both prevented from issuing a write sequence that is known to have the potential to cause a deadlock.

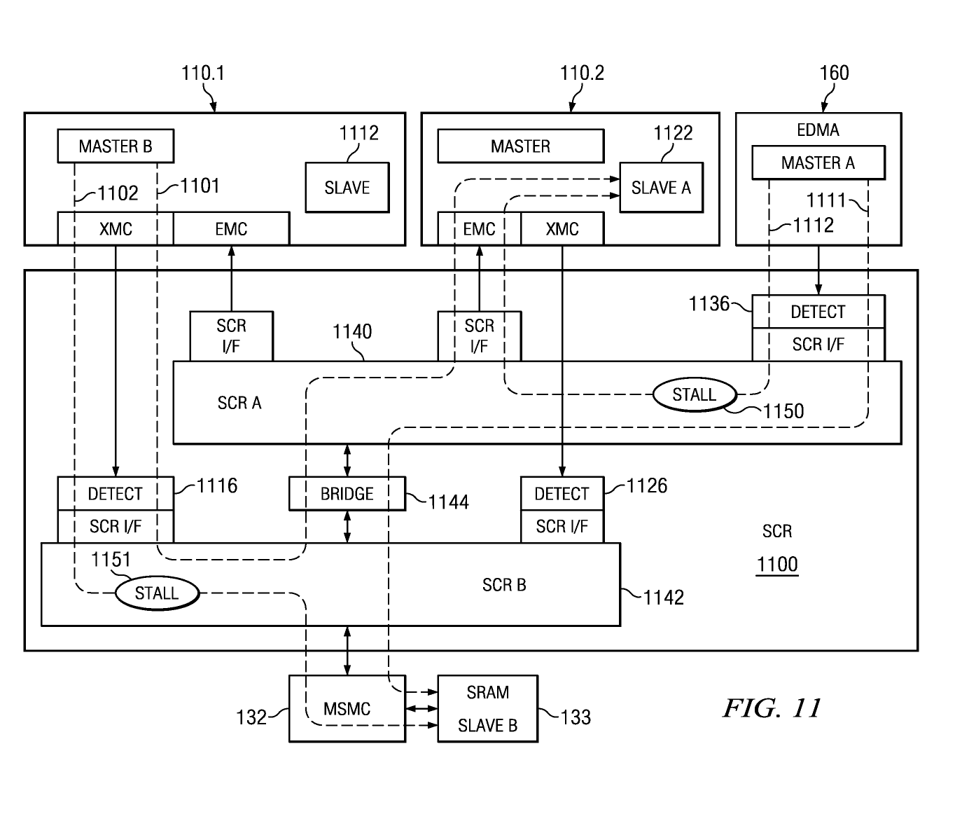

FIG. 11 is a schematic illustrating another situation in a packet based switch fabric 1100 where a deadlock could occur. This example includes processor modules 110.1, 110.2, as described above. In this embodiment, SCR 1100 is implemented as two separate portions 1140, 1142 that are coupled via bridge 1144. Each XMC is an SCR master interface and is coupled to SCR 1142 and provides access to shared SRAM 133 via MSMC 132, as described above. As such, SRAM 133 is considered a local resource to each processor module since they are on the same switch fabric portion. In this embodiment, SCR B 1142 does not extend into each processor module 110. Therefore, local accesses to resources within each processor module by a master within the same processor module do not use the SCR and deadlocking for those accesses is not a problem. These resources will be loosely referred to as slave 1112 and slave 1122 in this example. Each EMC is an SCR slave interface and is coupled to SCR 1140 to provide access by other masters to the shared resources 1112, 1122 within each processor module, as described with regard to FIGS. 2-4.

SCR portion 1140 is separated from SCR portion 1142 by bridge 1144; thus, any transaction initiated by a master on one processor module to a slave in another processor module must first traverse SCR 1142, bridge 1144 and then SCR 1140. Therefore, an access to a slave coupled to one SCR via bridge 1144 is treated as an external access to masters coupled to the other SCR. Shared memory 133 is coupled to SCR 1142; therefore any access by a master in processor module 110 via XMC and SCR 1142 is considered a local access.

Enhanced DMA (EDMA) 160, referring again to FIG. 1, is an enhanced DMA engine that may be used by any of the processor modules 110 move data from one memory to another within SoC 100. In FIG. 1, three copies of EDMA 160 are illustrated. The general operation of DMA engines is well known and will not be further described herein. Referring again to FIG. 11, EDMA 160 is coupled to SCR 1140 and therefore access to any shared resource 1112, 1122 via an EMC is treated as a local access, while an access via bridge 1144 to shared memory 133 coupled to SCR 1142 is treated as an external access.

Referring still to FIG. 11, in this example, EDMA 160 is referred to as master A. A master in processor module 110.1 is referred to as master B. Local shared memory 1122 in processor module 110.2 is referred to a as slave A. Shared RAM 133 is referred to as slave B. Master A may initiate an external write request 1111 to slave B, then initiate a local write request 1112 to slave A. At the same time, master B in processor module 110.1 may initiate an external write request 1101 to slave A, then initiate local write request 1102 to slave B SRAM 133. Since strict ordering is maintained on all transactions, the following conditions occur:
Write ordering from master A: write 1111 to remote slave B, write 1112 to local slave A
Write ordering from master B: write 1101 to remote slave A, write 1102 to local slave B
Writes data arrive in this order at slave A: local write 1112 is first, external write 1101 is second due to bridge delay
Writes data arrive in this order at slave B: local write 1102 is first, external write 1111 is second due to bridge delay
At slave A, external write 11011 could be blocked by completion of local write 1112 due to strict ordering enforcement
At slave A, local write 1112 could be prevented from start until external write 1101 is completed due to strict ordering enforcement
At slave B, external write 1111 could be blocked by completion of local write 1102 due to strict ordering enforcement
At slave B, local write 1102 could be prevented from start until external write 1111 is completed due to strict ordering enforcement

However, detection logic at the master interfaces to SCR 1140, 1142 is configured to detect an access pattern of external-local and then stall the local access until the external access is completed. In this example, detection logic 1116 detects the external 1101-internal 1102 access pattern and stalls 1151 internal access 1102 until external access 1101 is completed. Simultaneously, detection logic 1136 detects the external 1111-internal 1112 access pattern and stalls 1150 internal access 1112 until external access 1111 is completed. In this manner, deadlock is prevented in the packet switch fabric 1100.

As illustrated by FIGS. 10 and 11, the term “local” refer to resources local resources on a same SCR portion, while the term “external” or “remote” refer to resources that require traversing a bridge or other form of pipeline delay to access.

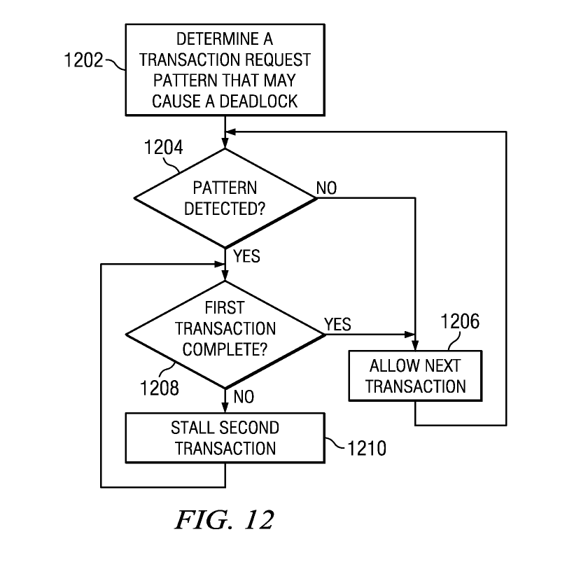

FIG. 12 is a flow diagram illustrating operation of the deadlock avoidance scheme described herein for managing transaction requests in an interconnect fabric in a system with multiple nodes. A pattern of transaction requests from a master device to various slave devices within the multiple nodes that may cause a deadlock is determined 1202 and stored. This is typically done offline as a result of analysis of a system operation, either by simulation, inspection, or diagnosis. As discussed above, in the interconnect SCR 224 of SoC 100, it has been determined that a write sequence of “write external followed by a write local” may cause a deadlock.

Determining 1202 patterns that may cause a deadlock may be done by simulating operation of the system with a sufficiently accurate simulator, or by observing operation of the system in a test bed, for example.

While the system is in operation, an occurrence of the pattern of transaction commands may be detected 1204 by observing a sequence of transaction requests from the master device. This is done by monitoring each transaction command issued by the master.

When the pattern is detected, a second transaction in the sequence of transaction commands is stalled 1210 until the first transaction in the sequence is complete 1208. Once the first transaction is complete 1208, then the next transaction is allowed 1206 to proceed.

As long as the pattern is not detected 1204, each transaction is allowed 1206 without any delay. For example, any read operation after a write is not stalled. Any local write followed by another local write is not stalled.

There may be more than one pattern that might cause a lockup. For example, if there are three SCR domains, then an external write from a first domain to a second domain followed by an external write from the first domain to the third domain may cause a lockup if either the second domain or third domain simultaneously tries to write to the first domain. In this case, pattern detection 1204 would check for both patterns.

### System Example

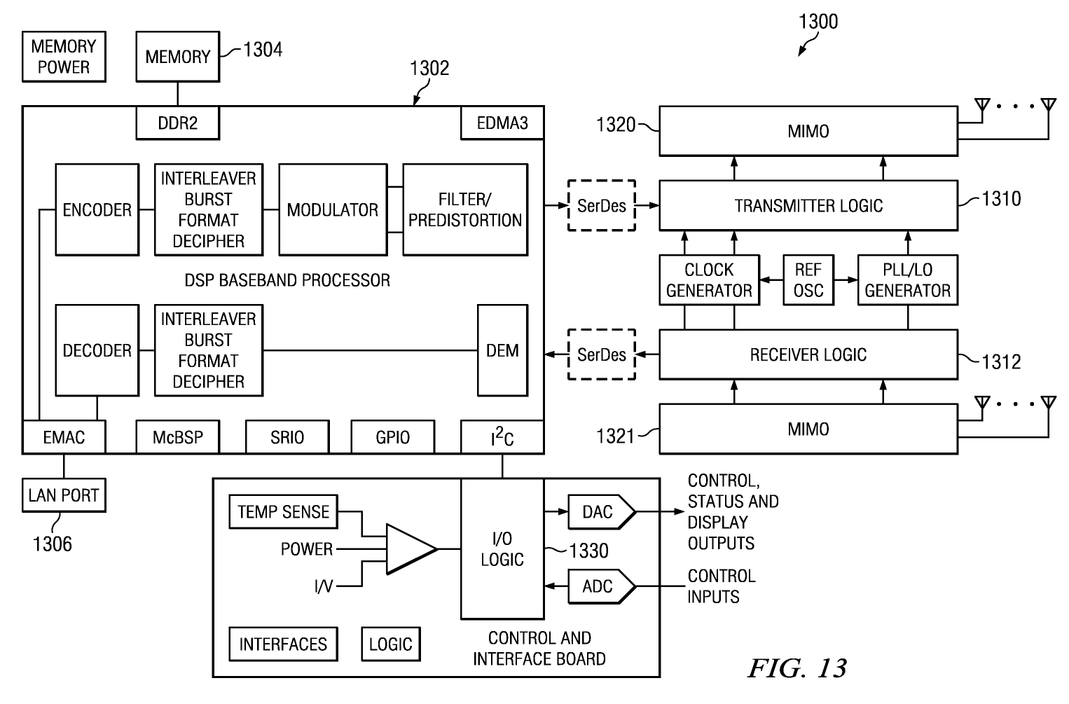

FIG. 13 is a block diagram of a base station for use in a radio network, such as a cell phone network. SoC 1302 is similar to the SoC of FIG. 1 and is coupled to external memory 1304 that may be used, in addition to the internal memory within SoC 1302, to store application programs and data being processed by SoC 1302. Transmitter logic 1310 performs digital to analog conversion of digital data streams transferred by the external DMA (EDMA3) controller and then performs modulation of a carrier signal from a phase locked loop generator (PLL). The modulated carrier is then coupled to multiple output antenna array 1320. Receiver logic 1312 receives radio signals from multiple input antenna array 1321, amplifies them in a low noise amplifier and then converts them to digital a stream of data that is transferred to SoC 1302 under control of external DMA EDMA3. There may be multiple copies of transmitter logic 1310 and receiver logic 1312 to support multiple antennas.

The Ethernet media access controller (EMAC) module in SoC 1302 is coupled to a local area network port 1306 which supplies data for transmission and transports received data to other systems that may be coupled to the internet.

An application program executed on one or more of the processor modules within SoC 1302 encodes data received from the internet, interleaves it, modulates it and then filters and pre-distorts it to match the characteristics of the transmitter logic 1310. Another application program executed on one or more of the processor modules within SoC 1302 demodulates the digitized radio signal received from receiver logic 1312, deciphers burst formats, and decodes the resulting digital data stream and then directs the recovered digital data stream to the internet via the EMAC internet interface. The details of digital transmission and reception are well known.

By stalling a sequential write transaction initiated by the various cores within SoC 1302 only when a pattern occurs that might result in a dead lock, data can be shared among the multiple cores within SoC 1302 such that data drops are avoided while transferring the time critical transmission data to and from the transmitter and receiver logic.

Input/output logic 1330 may be coupled to SoC 1302 via the inter-integrated circuit (I2C) interface to provide control, status, and display outputs to a user interface and to receive control inputs from the user interface. The user interface may include a human readable media such as a display screen, indicator lights, etc. It may include input devices such as a keyboard, pointing device, etc.

### Other Embodiments

Although the invention finds particular application to Digital Signal Processors (DSPs), implemented, for example, in a System on a Chip (SoC), it also finds application to other forms of processors. A SoC may contain one or more megacells or modules which each include custom designed functional circuits combined with pre-designed functional circuits provided by a design library.

While the invention has been described with reference to illustrative embodiments, this description is not intended to be construed in a limiting sense. Various other embodiments of the invention will be apparent to persons skilled in the art upon reference to this description. For example, in another embodiment, a different interconnect topology may be embodied. Each topology will need to be analyzed to determine which, if any, transaction patterns may possibly cause a dead lock situation. Once determined, then they can be monitored, detected and prevented as described herein.

In another embodiment, the shared resource may be just a memory that is not part of a cache. The shared resource may by any type of storage device or functional device that may be accessed by multiple masters in which access stalls by one master must not block access to the shared resource by another master.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method of managing transaction requests in an interconnect fabric in a system with multiple nodes, the method comprising:
storing a representation of a pattern of transaction requests from a master device to various slave devices within the multiple nodes that may cause a deadlock;
detecting an occurrence of the pattern by observing a sequence of transaction requests from the master device; and
stalling a transaction request in the detected pattern, whereby a deadlock is prevented.

2. The method of claim 2, wherein the pattern of transaction requests comprises a first write request from a master in a first node to a remote slave device followed by a second write request from the master in the first node to a local slave.

3. The method of claim 2, wherein the second write request is stalled until the first write request is completed.

4. The method of claim 2, wherein a read request following the second write request is not stalled while the second write request remains stalled.

5. The method of claim 2, wherein a write request from the master in the first node to a remote slave device in the second node followed by a second write request from the master in the first node to the remote slave in the second node does not cause a stall.

6. The method of claim 1, wherein representations of a plurality of determined patterns are stored and wherein detection of any one of the plurality of patterns causes a transaction request in the detected pattern to be stalled.

7. The method of claim 1, wherein each transaction request comprises a command packet and a separate data packet, wherein the data packet is separate from the command packet.

8. The method of claim 1, further comprising determining one or more patterns of access transaction requests from the master device to various slave devices within the multiple nodes that may cause a deadlock by simulating operation of the interconnect fabric.

9. The method of claim 1, further comprising determining one or more patterns of access transaction requests from the master device to various slave devices within the multiple nodes that may cause a deadlock by observing operation of the interconnect fabric in a test bed.

10. A system comprising:
an first interconnect fabric with one or more master interfaces for master devices and one or more slave interfaces for slave devices, wherein the interconnect fabric is configured to transport transactions between the master devices and the slave devices while enforcing strict transaction ordering;
a pattern storage circuit coupled to at least one of the master interfaces, the storage circuit configured to store a representation of a pattern of transaction requests from a master device to various slave devices coupled to the interconnect fabric that may cause a deadlock;
a detection circuit coupled to the at least one master interface, the detection circuit configured to detect an occurrence of the pattern by observing a sequence of transaction requests from the master device; and
stall logic coupled to the at least one master interface, wherein the stall logic is configured to stall a transaction request in the detected pattern, whereby a deadlock is prevented.

11. The system of claim 10, wherein the interconnect fabric includes a bridge interface for coupling to a bridge to another interconnect fabric, the system further comprising:
a bridge circuit coupled to the bridge interface;
a second interconnect fabric with one or more master interfaces for master devices and one or more slave interfaces for slave devices, wherein the second interconnect fabric is configured to transport transactions between the master devices and the slave devices while enforcing strict transaction ordering; and
wherein the pattern of transaction requests comprises a first write request from a master interface in the first interconnect fabric to a slave interface in the second interconnect fabric followed by a second write request from the master interface in the first interconnect fabric to a slave interface in the first interconnect fabric.

12. The system of claim 10, wherein a plurality of patterns are stored in the pattern storage circuit and wherein detection of any one of the plurality of patterns causes a transaction request in the detected pattern to be stalled.

13. The system of claim 11 comprising at least two master devices coupled to master interfaces and at least two slave devices coupled to slave interfaces.

14. The system of claim 13 being formed within a single integrated circuit.

15. A system on a chip comprising:
means for transporting transactions between master devices and slave devices while enforcing strict transaction ordering;
means for storing a representation of a pattern of transaction requests from a master device to various slave devices that may cause a deadlock;
means for detecting an occurrence of the pattern by observing a sequence of transaction requests from a master device; and
means for staling a transaction request in the detected pattern, whereby a deadlock is prevented.
